(19) United States
(12) Patent Application Publication
(10) Pub. No.: US 2024/0389037 A1
(43) Pub. Date: Nov. 21, 2024

(54) TRANSMITTING SINGLE-CARRIER SYNCHRONIZATION SIGNAL BLOCK

(71) Applicant: Lenovo (Singapore) Pte. Ltd., New Tech Park (SG)

(72) Inventors: Sher Ali Cheema, Ilmenau (DE); Seyedomid Taghizadeh Motlagh, Oberursel (DE); Ankit Bhamri, Rödermark (DE); Ali Ramadan Ali, Kraiburg am Inn (DE)

(21) Appl. No.: 18/690,666

(22) PCT Filed: Sep. 8, 2022
(86) PCT No.: PCT/IB2022/058481

§ 371 Date: Mar. 8, 2024

Related U.S. Application Data
(60) Provisional application No. 63/241,938, filed on Sep. 8, 2021.

(51) Int. Cl. H04W 56/00; H04L 5/00; H04W 72/0446; H04W 72/30

(52) U.S. Cl. CPC H04W 56/0015; H04L 5/0051; H04W 72/0446; H04W 72/30

(57) ABSTRACT

Apparatuses, methods, and systems are disclosed for SSB pattern enhancement. One method includes receiving a single-carrier SSB structure from a radio access network. Here, the single-carrier SSB structure includes: a PSS portion comprising a PSS block mapped to a first set of time-domain symbols, a SSS portion comprising a SSS block mapped to a second set of time-domain symbols, and a PBCH portion comprising a plurality of PBCH blocks mapped to a third set of time-domain symbols. The method includes accessing a cell using a single-carrier waveform based on the received single-carrier SSB structure.

### CROSS-REFERENCE TO RELATED APPLICATIONS

This application claims priority to U.S. Provisional Patent Application No. 63/241,938 entitled “PATTERN ENHANCEMENT FOR SYNCHRONIZATION SIGNAL BLOCK” and filed on 8 Sep. 2021 for Sher Ali Cheema, Seyedomid Taghizadeh Motlagh, Ankit Bhamri, and Ali Ramadan Ali, which application is incorporated herein by reference.

### FIELD

The subject matter disclosed herein relates generally to wireless communications and more particularly relates to schemes for synchronization signal block (“SSB”) structure enhancement, e.g., for single carrier waveforms.

### BACKGROUND

Currently in Third Generation Partnership Project (“3GPP”) New Radio (“NR”), synchronization signal block (“SSB”) design is specific to Cyclic Prefix-Orthogonal Frequency Division Multiplexing (“CP-OFDM”). It is expected that new waveforms will be considered for NR operation in Frequency Range #2 (“FR2”, i.e., frequencies from 24.25 GHz to 52.6 GHz) and for beyond 71 GHz.

In current NR releases, only CP-OFDM is supported for downlink (“DL”) while CP-OFDM and Discrete Fourier Transform Spread Orthogonal Frequency Division Multiplexing (“DFT-s-OFDM”) are supported for uplink (“UL”). However, CP-OFDM performance degrades at high frequencies (e.g., FR2 and/or beyond 71 GHz) due to its sensitivity to phase noise and its high Peak-to-Average Power Ratio (“PAPR”) or cubic metric (“CM”) that limits the cell coverage, edge of cell performance and higher User Equipment (“UE”) power consumption.

### BRIEF SUMMARY

Disclosed are procedures for SSB pattern enhancement. Said procedures may be implemented by apparatus, systems, methods, or computer program products.

One method at a User Equipment (“UE”) includes receiving a Single-Carrier Synchronization Signal Block (“SC-SSB”) structure from a radio access network. Here, the SC-SSB structure includes: a Primary Synchronization Signal (“PSS”) portion comprising a PSS block mapped to a first set of time-domain symbols, a Secondary Synchronization Signal (“SSS”) portion comprising a SSS block mapped to a second set of time-domain symbols, and a Physical Broadcast Channel (“PBCH”) portion comprising a plurality of PBCH blocks mapped to a third set of time-domain symbols. The method includes accessing a cell using a single-carrier waveform based on the received SC-SSB structure.

One method at a network device includes transmitting a SC-SSB structure. Here, the SC-SSB structure includes: a PSS portion comprising a PSS block mapped to a first set of time-domain symbols, a SSS portion comprising a SSS block mapped to a second set of time-domain symbols, and a PBCH portion comprising a plurality of PBCH blocks mapped to a third set of time-domain symbols. The method includes receiving a connection request from a UE.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a block diagram illustrating one embodiment of a wireless communication system for SSB pattern enhancement:

FIG. 1B is a block diagram showing one embodiment of a time/frequency structure of a single SSB Type-1 structure:

FIG. 2 is a block diagram illustrating one embodiment of a Fifth-Generation (“5G”) New Radio (“NR”) protocol stack:

FIG. 3A is a diagram illustrating one embodiment of structure for SSB Type-2: FIG. 3B is a diagram illustrating another embodiment of a structure for SSB Type-2:

FIG. 4A is a diagram illustrating one embodiment of a first alternative structure for SSB Type-3:

FIG. 4B is a diagram illustrating one embodiment of a second alternative structure for SSB Type-3:

FIG. 4C is a diagram illustrating one embodiment of a third alternative structure for SSB Type-3:

FIG. 4D is a diagram illustrating one embodiment of a fourth alternative structure for SSB Type-3:

FIG. 5 is a diagram illustrating one embodiment of an SSB structure with embedded demodulation reference signal (“DM-RS”) and/or Cyclic Prefix (“CP”) into the PSS/SSS:

FIG. 6 is a diagram illustrating one embodiment of a Master Information Block (“MIB”) sent via PBCH:

FIG. 7 is a block diagram illustrating one embodiment of a user equipment apparatus that may be used for SSB pattern enhancement:

FIG. 8 is a block diagram illustrating one embodiment of a network apparatus that may be used for SSB pattern enhancement: and

FIG. 9 is a flowchart diagram illustrating one embodiment of a first method for SSB pattern enhancement: and

FIG. 10 is a flowchart diagram illustrating one embodiment of a second method for SSB pattern enhancement.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatuses for mechanisms for SSB pattern enhancement. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

In 3GPP Release 18 (“ Rel-18”) or beyond, it is expected that new waveforms will be considered for NR operation in higher frequency ranges, e.g., FR2 and beyond 71 GHz. Note that Frequency Range #1 (“FR1”) refers to frequencies from 410 MHz to 7125 MHz.

In current NR releases, only CP-OFDM is supported for DL while CP-OFDM and DFT-s-OFDM are supported for UL. CP-OFDM performance degrades at high frequencies (e.g., beyond 71 GHz) due to its sensitivity to phase noise and its high PAPR or CM that limits the cell coverage, edge of cell performance and higher UE power consumption. Any new waveform such as DFT-s-OFDM, Single-Carrier Frequency Domain Equalization (“SC-FDE”), Single Carrier Quadrature Amplitude Modulation (“SC-QAM”) or some other single carrier waveform is expected to be specified for 5G-Advanced in addition to CP-OFDM.

Currently in NR. SSB design is specific to CP-OFDM with frequency domain where Primary Synchronization Signal (“PSS”), Secondary Synchronization Signal (“SSS”), and Physical Broadcast Channel (“PBCH”) are mapped across time and frequency resources. The SSB pattern needs to be adapted for single carrier/SC-FDE waveform as the resources are mapped on the time domain resources. Specifically, the design may depend on how DM-RS are mapped to SC-FDE waveform. Currently, no such design is supported in NR.

If single carrier waveform such as SC-FDE is adopted for UL/DL, many reference signals/patterns shall be redesigned as these reference signals will be employed in the time domain. Especially if single carrier or SC-FDE is also adopted for initial access, the SSB structure may need to be redesigned for single carrier operation, where PSS, SSS, and PBCH are mapped only to the time domain resources.

The solutions described herein disclose new SSB structures are proposed that may be employed for either single carrier waveform or SC-FDE waveform or combination of both, where the PSS, SSS, and PBCH payload is distributed over only time-domain resources. Specifically, the SSB pattern depends on whether: A) guard-interval is random for each block, thus requiring at least one dedicated block for DM-RS: or B) guard interval is known such that DM-RSs are part of guard-interval, and thus may not need a dedicated block for DM-RS.

One or more of the new SSB structures integrate enhancements to PSS and SSS design, e.g., the guard interval is part of synchronization signal. One or more of the new SSB structures integrate modifications and/or restrictions to the PBCH payload, e.g., MIB configuration with relevant time-domain parameters. One or more of the new SSB structures integrate enhancements to SSB and Physical Downlink Control Channel (“PDCCH”) Control Resource Set Number ‘0’ (“CORESET#0”) multiplexing patterns.

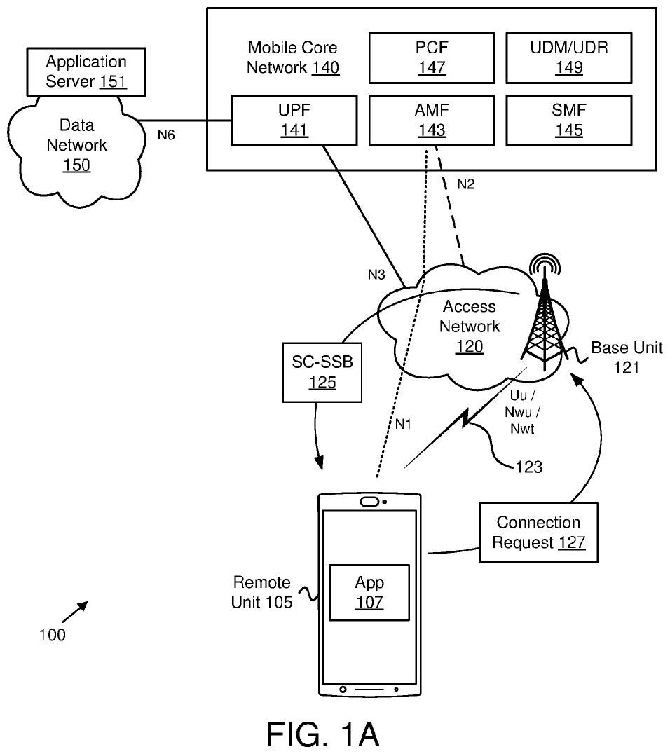

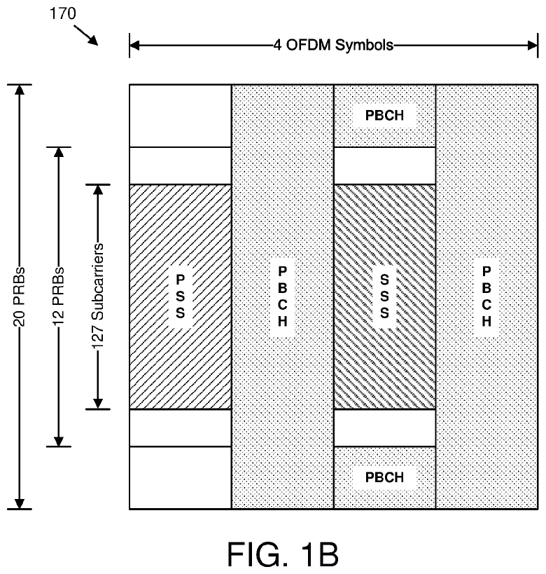

FIG. 1A depicts a wireless communication system 100 for SSB pattern enhancement, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1A, one of skill in the art will recognize that any number of remote units 105, base units 121, wireless communication links 123, RANs 120, and mobile core networks 140 may be included in the wireless communication system 100.

In one implementation, the RAN 120 is compliant with the 5G cellular system specified in the 3GPP specifications. For example, the RAN 120 may be a Next Generation Radio Access Network (“NG-RAN”), implementing NR Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example, the Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via UL and DL communication signals. Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more DL channels, such as the PDCCH and/or Physical Downlink Shared Channel (“PDSCH”). Here, the RAN 120 is an intermediate network that provides the remote units 105 with access to the mobile core network 140.

In various embodiments, the remote units 105 may communicate directly with each other (e.g., device-to-device communication) using sidelink communication. Here, sidelink transmissions may occur on sidelink resources. A remote unit 105 may be provided with different sidelink communication resources according to different allocation modes. As used herein, a “resource pool” refers to a set of resources assigned for sidelink operation. A resource pool consists of a set of resource blocks (i.e., Physical Resource Blocks (“PRB”)) over one or more time units (e.g., Orthogonal Frequency Division Multiplexing (“OFDM”) symbols, subframe, slots, subslots, etc.). In some embodiments, the set of resource blocks comprises contiguous PRBs in the frequency domain. A PRB, as used herein, consists of twelve consecutive subcarriers in the frequency domain.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or Packet Data Network (“PDN”) connection) with the mobile core network 140 via the RAN 120. The PDU session represents a logical connection between the remote unit 105 and the User Plane Function (“UPF”) 141. The mobile core network 140 then relays traffic between the remote unit 105 and the application server 151 in the packet data network 150 using the PDU session (or other data connection).

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a PDN connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW”, not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “CNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

To facilitate cell access, the RAN 120 transmits (e.g., periodically) a synchronization signal (e.g., PSS and SSS) and PBCH, which comprise an SSB. For example, each base unit 121 in the RAN 120 may transmit a set of SSB. The periodicity, number repetitions, time-domain location/offset, and other parameters of the SSB may depend on the carrier frequency and subcarrier spacing (“SCS”) of the cell. For single-carrier operation (e.g., at higher frequency), a base unit 121 may transmit/broadcast a SC-SSB 125, where the PSS, SSS, and PBCH are mapped to time-domain resources according to the embodiments described in the present disclosure. The remote unit 105 uses the information in the SC-SSB 125 to access a particular cell using a single-carrier waveform, e.g., by transmitting a connection request 127 to a respective base unit 121 supporting the particular cell.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1A, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering and integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation and management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“cMBB”) service. As another example, one or more network slices may be optimized for ultra-reliable low-latency communication (“URLLC”) service. In other examples, a network slice may be optimized for machine-type communication (“MTC”) service, massive MTC (“mMTC”) service, Internet-of-Things of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1A for ease of illustration, but their support is assumed.

While FIG. 1A depicts components of a 5G RAN and a 5G core network, the described embodiments for SSB pattern enhancement apply to other types of communication networks and RATs, including IEEE 802.11 variants, Global System for Mobile Communications (“GSM”, i.e., a 2G digital cellular network), General Packet Radio Service (“GPRS”), Universal Mobile Telecommunications System (“UMTS”), LTE variants, CDMA2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

In the following descriptions, the term “RAN node” is used for the base station/base unit, but it is replaceable by any other radio access node, e.g., gNB, ng-eNB, eNB, Base Station (“BS”), base station unit, Access Point (“AP”), NR BS, 5G NB, Transmission and Reception Point (“TRP”), etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for SSB pattern enhancement.

Several solutions to provide SC-SSB structures/patterns are described below. According to a possible embodiment, one or more elements or features from one or more of the described solutions may be combined.

In NR, the primary and secondary synchronization signals are used by the UE for initial cell search and to obtain frame timing, Cell identity (“ID”), and to find the reference signals for coherent demodulation of other channels. SSB transmission is based on Orthogonal Frequency Division Multiplexing (“OFDM”) that is transmitted on a set of time/frequency resources (resource elements) within the basic OFDM grid and using the same numerology.

FIG. 1B illustrates the time/frequency structure 170 of a single SSB transmission. This is referred to herein as “SSB Type-1”. As can been seen, a Synchronization Signal/Physical Broadcast Channel (“SS/PBCH”) block consists of four OFDM symbols in the time domain, numbered in increasing order from 0 to 3 within the SSB, where Primary Synchronization Signal (“PSS”), Secondary Synchronization Signal (“SSS”), and Physical Broadcast Channel (“PBCH”) with the associated Demodulation Reference Signal (“DM-RS”) are mapped to symbols according to Table 1.

TABLE 1
Resources within an SSB for PSS,
SSS, PBCH, and DM-RS for PBCH

| | OFDM symbol number | Subcarrier number k |
|---|---|---|
| Channel | l relative to the start | relative to the start |
| or signal | of an SS/PBCH block | of an SS/PBCH block |
| PSS | 0 | 56, 57, . . . , 182 |
| SSS | 2 | 56, 57, . . . , 182 |
| Set to 0 | 0 | 0, 1, . . . , 55, 183, 184, . . . , 239 |
| | 2 | 48, 49, . . . , 55, 183, 184, . . . , |
| | | 191 |
| PBCH | 1, 3 | 0, 1, . . . , 239 |
| | 2 | 0, 1, . . . , 47, |
| | | 192, 193, . . . , 239 |
| DM-RS | 1, 3 | 0 + ν, 4 + ν, 8 + ν, . . . , 236 + ν |
| for | 2 | 0 + ν, 4 + ν, 8 + ν, . . . , 44 + ν |
| PBCH | | 192 + ν, 196 + ν, . . . , 236 + ν |

In the frequency domain, an SS/PBCH block consists of 240 contiguous subcarriers with the subcarriers numbered in increasing order from 0 to 239 within the SS/PBCH block. The quantities ‘k’ and ‘l’ represent the frequency and time indices, respectively, within one SSB. The quantity ‘v’ in Table 1 is given by v=N_{ID}^{cell} mod 4. The total number of resource elements used for PBCH with the associated DM-RS per SSB equals to 576 while PSS and SSS each occupy 127 resource elements.

The PSS is a physical layer signal used for synchronization. The PSS sequence is derived based on the physical cell ID. The formula for generating NR PSS is described in 3GPP Technical Specification (“TS”) 38.211. The SSS is also a physical layer signal used for synchronization. The SSS sequence is also derived based on the physical cell ID. The formula for generating NR SSS is also described in 3GPP TS 38.211. The PBCH payload comprises the MIB.

Current NR describes two types of SSB Type-1, that is, Type A and Type B, where the former is specified for operation in sub-6 GHz frequency range with SubCarrier Spacing (“SCS”) of 15 kHz and 30 kHz and the latter is defined for FR2 bands with SCS options of 120 kHz and 240 kHz.

The maximum number of SSBs (Lmax) differ for different frequency range, i.e., Lmax=4 for FR1<3 GHz. Lmax=8 for 3 GHZ<FR1<6 GHZ, and Lmax=64 for FR2.

The SSBs are indexed in an ascending order in time within a half frame from 0 to Lmax−1. Within the SSB indices, two or three least-significant bits (“LSBs”) are carried by changing the DM-RS sequence of PBCH. Thus, for the sub-6 GHz frequency range, the UE can acquire the SSB index without decoding the PBCH. A UE determines the 2 LSBs, for Lmax=4, or the 3 LSBs, for Lmax>4, of an SSB index per half frame from a one-to-one mapping with and index of the DM-RS sequence transmitted in the PBCH. For Lmax=64, the UE determines the 3 most-significant bits (“MSBs”) of the SSB index per half frame from the PBCH payload bits.

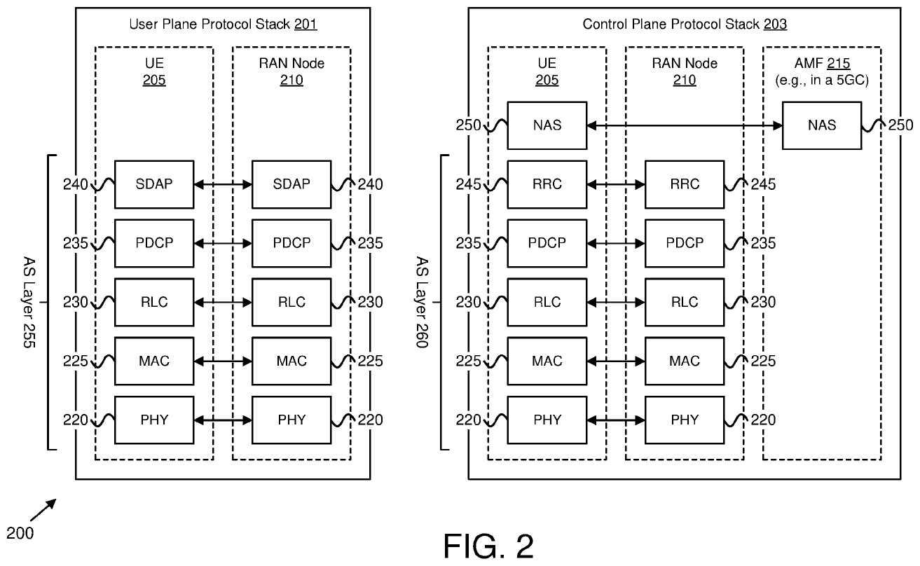

FIG. 2 depicts a NR protocol stack 200, according to embodiments of the disclosure. While FIG. 2 shows the UE 205, the RAN node 210 and an AMF 215 in a 5G core network (“5GC”), these are representative of a set of remote units 105 interacting with a base unit 121 and a mobile core network 140. As depicted, the NR protocol stack 200 comprises a User Plane protocol stack 201 and a Control Plane protocol stack 203. The User Plane protocol stack 201 includes a physical (“PHY”) layer 220, a Medium Access Control (“MAC”) sublayer 225, the Radio Link Control (“RLC”) sublayer 230, a Packet Data Convergence Protocol (“PDCP”) sublayer 235, and Service Data Adaptation Protocol (“SDAP”) layer 240. The Control Plane protocol stack 203 includes a PHY layer 220, a MAC sublayer 225, a RLC sublayer 230, and a PDCP sublayer 235. The Control Plane protocol stack 203 also includes a Radio Resource Control (“RRC”) layer 245 and a Non-Access Stratum (“NAS”) layer 250.

The AS layer 255 (also referred to as “AS protocol stack”) for the User Plane protocol stack 201 consists of at least SDAP, PDCP, RLC and MAC sublayers, and the physical layer. The AS layer 260 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC layer 245 and the NAS layer 250 for the control plane and includes, e.g., an IP layer and/or PDU Layer (not depicted) for the user plane. L1 and L2 are referred to as “lower layers,” while L3 and above (e.g., transport layer, application layer) are referred to as “higher layers” or “upper layers.”

The PHY layer 220 offers transport channels to the MAC sublayer 225. The PHY layer 220 may perform a beam failure detection procedure using energy detection thresholds, as described herein. In certain embodiments, the PHY layer 220 may send an indication of beam failure to a MAC entity at the MAC sublayer 225. The MAC sublayer 225 offers logical channels to the RLC sublayer 230. The RLC sublayer 230 offers RLC channels to the PDCP sublayer 235. The PDCP sublayer 235 offers radio bearers to the SDAP sublayer 240 and/or RRC layer 245. The SDAP sublayer 240 offers QoS flows to the core network (e.g., 5GC). The RRC layer 245 provides for the addition, modification, and release of Carrier Aggregation and/or Dual Connectivity. The RRC layer 245 also manages the establishment, configuration, maintenance, and release of Signaling Radio Bearers (“SRBs”) and Data Radio Bearers (“DRBs”).

The NAS layer 250 is between the UE 205 and an AMF 215 in the 5GC. NAS messages are passed transparently through the RAN. The NAS layer 250 is used to manage the establishment of communication sessions and for maintaining continuous communications with the UE 205 as it moves between different cells of the RAN. In contrast, the AS layers 255 and 260 are between the UE 205 and the RAN (i.e., RAN node 210) and carry information over the wireless portion of the network. While not depicted in FIG. 2, the IP layer exists above the NAS layer 250, a transport layer exists above the IP layer, and an application layer exists above the transport layer.

The MAC sublayer 225 is the lowest sublayer in the L2 architecture of the NR protocol stack. Its connection to the PHY layer 220 below is through transport channels, and the connection to the RLC sublayer 230 above is through logical channels. The MAC sublayer 225 therefore performs multiplexing and demultiplexing between logical channels and transport channels: the MAC sublayer 225 in the transmitting side constructs MAC PDUs (also known as transport blocks (“TBs”)) from MAC Service Data Units (“SDUs”) received through logical channels, and the MAC sublayer 225 in the receiving side recovers MAC SDUs from MAC PDUs received through transport channels.

The MAC sublayer 225 provides a data transfer service for the RLC sublayer 230 through logical channels, which are either control logical channels which carry control data (e.g., RRC signaling) or traffic logical channels which carry user plane data. On the other hand, the data from the MAC sublayer 225 is exchanged with the PHY layer 220 through transport channels, which are classified as UL or DL. Data is multiplexed into transport channels depending on how it is transmitted over the air.

The PHY layer 220 is responsible for the actual transmission of data and control information via the air interface, i.e., the PHY Layer 220 carries all information from the MAC transport channels over the air interface on the transmission side. Some of the important functions performed by the PHY layer 220 include coding and modulation, link adaptation (e.g., Adaptive Modulation and Coding (“AMC”)), power control, cell search and random access (for initial synchronization and handover purposes) and other measurements (inside the 3GPP system (i.e., NR and/or LTE system) and between systems) for the RRC layer 245. The PHY layer 220 performs transmissions based on transmission parameters, such as the modulation scheme, the coding rate (i.e., the modulation and coding scheme (“MCS”)), the number of physical resource blocks, etc.

Several solutions to provide different enhancements for SSB pattern for single carrier waveform, including SC-FDE, are described below. SC-FDE is a single-carrier modulation combined with frequency-domain equalization (“FDE”). Beneficially, the SSB structure on time domain resources may be arranged such that the payload for PSS, SSS, and PBCH remains at least the same as of the current NR Release 16 (“Rel-16”) SSB structure that employs CP-OFDM waveform.

In some embodiments, the SSB structure varies based on how the DM-RS is employed. For example, SC-FDE can either employ a random guard interval or a known guard interval inside the Fast Fourier Transform (“FFT”) block to facilitate the frequency domain processing at the receiver. If a random guard interval is employed, then at least one FFT size block is dedicated for Demodulation Reference Signal (“DM-RS”), while for the case of known guard interval, the guard interval itself can be utilized for DM-RS. As used herein, a “FFT size block” refers to a block of resources whose size is equal to the length of the FFT block.

In the following one or more embodiments are described. It is understood that the disclosure is not limited to the embodiments individually, and one or more elements from one or more embodiments may be combined.

According to embodiments of a first solution, a SC-SSB pattern for SC-FDE waveform utilizes a random block-wise guard interval with a dedicated block of N-FFT size for DM-RS. In various embodiments of the first solution, the current NR Rel-16 SSB structure (for CP-OFDM waveform) is reused for SC-FDE waveform in such a way that the payload for PSS, SSS, and PBCH remain at least the same, but the payload is mapped only on the time domain resources. In such embodiments, the PSS, SSS, and PBCH are distributed among a number of N-FFT size blocks with a Cyclic Prefix (“CP”) (i.e., a random block-wise guard interval) being inserted periodically to each N-FFT size block. In order to distinguish from SSB Type-1, this new type of SC-SSB pattern may be referred to as “SSB Type-2,” as an example.

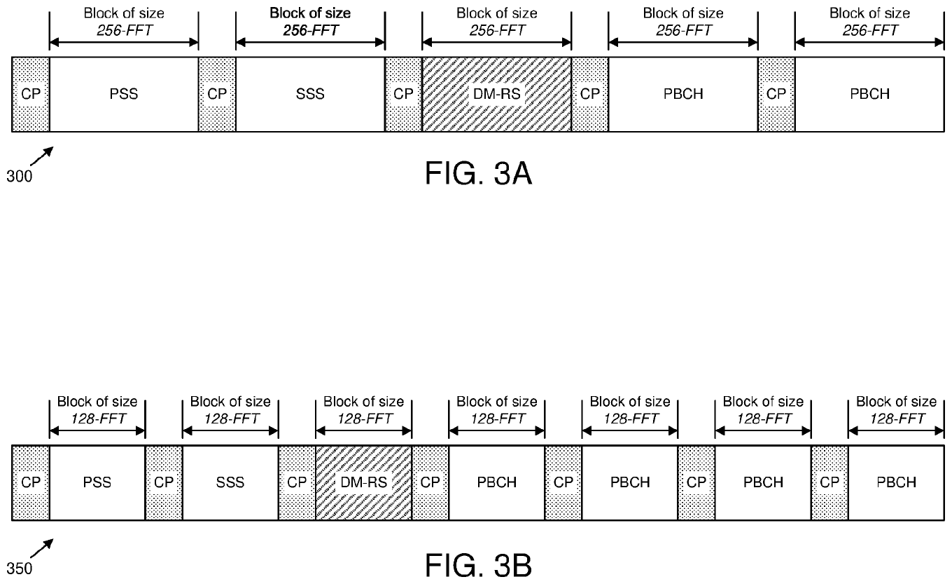

FIG. 3A depicts one implementation 300 of a SSB Type-2, according to embodiments of the disclosure. In the depicted implementation 300, time-domain blocks of FFT-size 256 (referred to as “256-FFT size” blocks) are used to accommodate the PSS, SSS, and PBCH payload, where a total of five time-domain blocks are used in the SSB pattern of SSB Type-2, that includes a dedicated block for DM-RS to increase the robustness against frequency selective channels. Note that the CP (guard interval) is not a part of the respective 256-FFT size blocks. In one implementation, the length of PSS and SSS symbols are kept the same as for SSB Type-1 (i.e., 127 elements/symbols) and are mapped to a 256-FFT size block in the time domain, with the remaining length in the 256-FFT size block being unused. In another implementation, the length of PSS and SSS sequences may be extended to the size of block, i.e., 256. In addition to PSS and SSS blocks, a 256 length DM-RS block is used in the SSB pattern, while two blocks are dedicated for PBCH payload. If only SSB Type-1 PBCH payload is supported (432 modulated symbols), then the remaining block length is unused.

FIG. 3B depicts another implementation 350 of a SSB Type-2 with reduced time duration, according to embodiments of the disclosure. In the depicted implementation 350, a block length of 128 is used, which is approximately the same length as the PSS and the SSS used in SSB Type-1. Accordingly, a total of 7 time-domain blocks of length 128 are used (referred to as “128-FFT size” block), where PSS, SSS, and DM-RS are mapped one block each and four blocks are used for PBCH, as shown in FIG. 3B. The CP (guard interval) is not a part of the respective 128-FFT size blocks. Note that overall time duration of the implementation 350 is smaller than the implementation 300 (which uses 256-FFT size block) in FIG. 3A because the block size is halved even though more CPs are inserted.

In another embodiment, the SSB Type-2 may use variable FFT block sizes. For example, the PSS and SSS may each use 128-FFT size blocks, while DM-RS and PBCH may utilize 256-FFT size blocks. Such a SC-SSB structure would be a hybrid of the implementations 300 and 350, described above, having two 128-FFT size blocks (for PSS and SSS) and three 256-FFT size blocks (for DM-RS and PBCH). In this example, the overall time duration would be smaller than either the implementation 350 in FIG. 3B (which uses seven 128-FFT size blocks) and the implementation 300 in FIG. 3A (which uses five 256-FFT size blocks).

In some embodiments, the time duration of the SSB Type-2 structure depends upon the allocated bandwidth. In one implementation, the bandwidth allocated for the SSB Type-1 for different subcarrier spacing is used for SSB Type-2. Especially, if 128-FFT size block structure in FIG. 3B is used, then the SSB time duration is approximately the same as the SSB Type-1 for different SCSs, thus giving the flexibility to utilize the same time durations as for SSB Type-1.

In another implementation, the bandwidth allocation for SSB Type-2 may be fixed according to different frequency ranges and predefined in the specification, e.g., a smaller bandwidth for FRI and a larger bandwidth for higher frequencies (FR2 and beyond). The CP duration may also be defined according to the frequency ranges. In one example, using the same numerology as defined for CP-OFDM in NR Rel 16 for different SCSs, the same CP duration and SSB bandwidth may be used and fixed for different frequency ranges for SC-FDE.

An example table showing bandwidth, CP duration, and the corresponding SSB duration for SSB Type-2 is shown in Table 2.

TABLE 2
An example relationship between SSB bandwidth,
CP duration, and frequency range for SSB Type-2

| | | | SSB Type-2 | SSB Type-2 |
|---|---|---|---|---|
| | SSB | CP | duration for | duration for |
| Frequency | Bandwidth | Duration | 128-FFT block | 256-FFT block |
| Range | (MHz) | (μs) | (μs) | (μs) |
| FR1 (<3 GHz) | 3.6 | 4.69 | ≈281.7 | ≈379 |
| FR1 (3-6 GHz) | 7.2 | 2.34 | ≈140.8 | ≈189.5 |
| FR2 (6-30 | 14.4 | 1.17 | ≈70.4 | ≈94.7 |
| GHz) | | | | |
| FR2 (20-35 | 28.8 | 0.59 | ≈35.2 | ≈47.4 |
| GHz) | | | | |
| FR2 (35-52 | 57.6 | 0.29 | ≈17.6 | ≈23.7 |
| GHz) | | | | |

According to embodiments of a second solution, the SSB pattern for the SC-FDE waveform utilizes the guard interval for the DM-RS with no dedicated block of N-FFT size for the DM-RS. In various embodiments of the first solution, the current NR Rel-16 SSB structure (for CP-OFDM waveform) is reused for the SC-FDE waveform in such a way that the payload for the PSS, SSS, and PBCH remain at least the same, but the payload is mapped only on the time domain resources. In such embodiments, the PSS, SSS, and PBCH are distributed among a number of N-FFT size blocks with the DM-RS being placed either at the start or at the end of data/data samples. In some embodiments, an additional DM-RS of guard interval length (also referred to as “guard-length”) may be added after the last block (or prior to the first block) to fulfill the cyclic property. In order to distinguish from SSB Type-1 and SSB Type-2, this new type of SC-SBB pattern may be referred to as “SSB Type-3,” as an example.

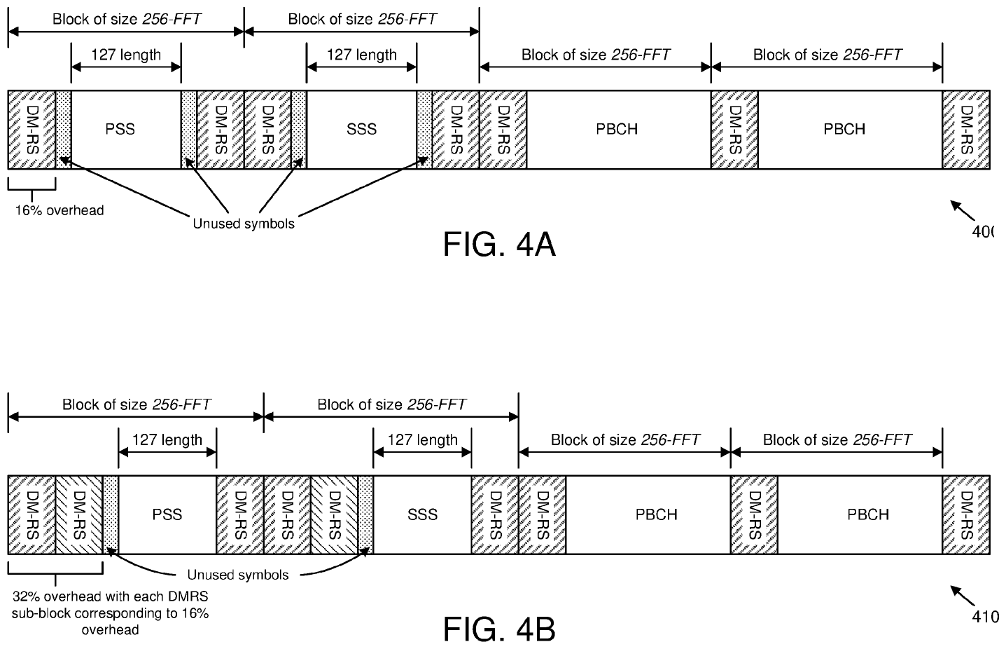

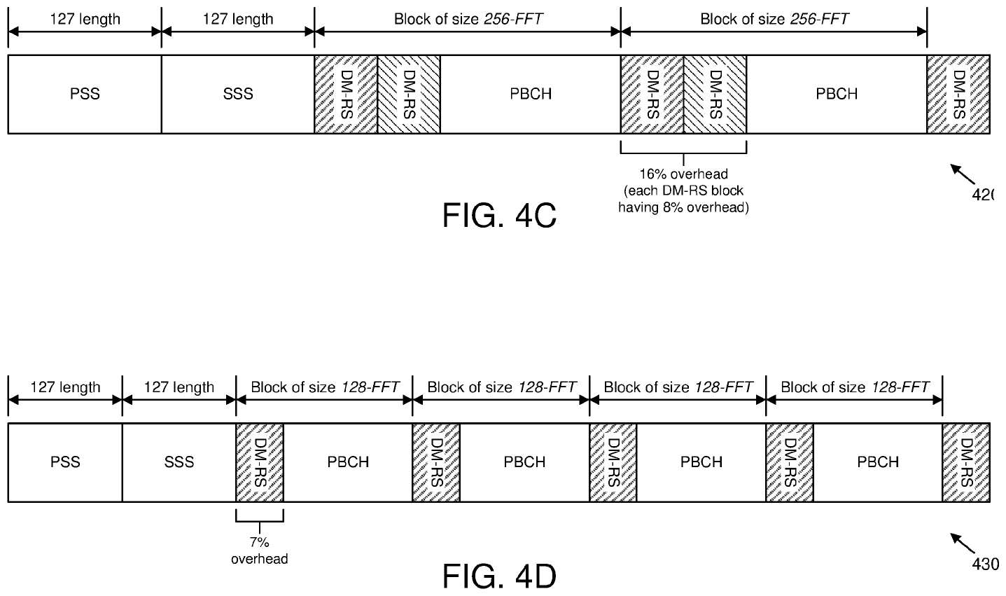

In some implementations of the second solution, the SSB Type-3 structure consists of four 256-FFT size blocks, where one block is used for the PSS, one block is used for the SSS, and two blocks are used for the PBCH. As discussed above, an additional guard-length DM-RS is placed after the end of the last PBCH block. The first and second blocks utilize the same length of the PSS and SSS, i.e., 127 elements/symbols, as defined in NR Rel-16 specifications for CP-OFDM but mapped only to the time domain resources. There may be many block combinations that may be adopted since only half of the block length is occupied by the PSS and SSS. FIGS. 4A-4D illustrates implementations of different SC-SSB structures that may be employed.

FIG. 4A depicts a first exemplary SSB Type-3 structure 400, according to embodiments of the disclosure. In the SSB Type-3 structure 400, a first block (e.g., a 256-FFT size block) comprises a 127-length PSS, a first DM-RS at the beginning of the block (i.e., with 16% overhead), and a second DM-RS at the end of the block, with unused symbols forming gaps between the first DM-RS and the PSS and between the PSS and the second DM-RS.

The SSB Type-3 structure 400 includes a second block (also a 256-FFT size block) that comprises a 127-length SSS, a first DM-RS at the beginning of the block (i.e., with 16% overhead), and a second DM-RS at the end of the second block, where unused symbols form gaps between the first DM-RS and the SSS and between the SSS and the second DM-RS.

The SSB Type-3 structure 400 includes third and fourth blocks (256-FFT size blocks), each containing a DM-RS and a portion of the PBCH. In the depicted embodiment, the DM-RS in each of the third and fourth blocks is located at the beginning of the respective block, and an additional guard-length DM-RS is added after the last block to fulfill the cyclic property. In a variant of the SSB Type-3 structure 400, the DM-RS in the third and fourth blocks is located at the end of each respective block.

FIG. 4B depicts a second exemplary SSB Type-3 structure 410, according to embodiments of the disclosure. In the SSB Type-3 structure 410, the first block (e.g., a 256-FFT size block) comprises a pair of DM-RS at the beginning of the block (i.e., with 32% overhead total, with each DM-RS block corresponding to 16% overhead), a 127-length PSS, and a third DM-RS at the end of the block, with unused symbols forming a gap between the second DM-RS and the PSS.

The SSB Type-3 structure 410, includes a second block (also a 256-FFT size block) that comprises a pair of DM-RS at the beginning of the block (i.e., with 32% overhead total, with each DM-RS block corresponding to 16% overhead), a 127-length SSS, and a third DM-RS at the end of the block, with unused symbols forming a gap between the second DM-RS and the SSS.

The SSB Type-3 structure 410 includes third and fourth blocks (256-FFT size blocks), each containing a DM-RS and a portion of the PBCH. In the depicted embodiment, the DM-RS in each of the third and fourth blocks is located at the beginning of the respective block, and an additional guard-length DM-RS is added after the last block to fulfill the cyclic property. In a variant of the SSB Type-3 structure 410, the DM-RS in the third and fourth blocks is located at the end of each respective block.

FIG. 4C depicts a third exemplary SSB Type-3 structure 420, according to embodiments of the disclosure. In the SSB Type-3 structure 420, a 127-length PSS and a 127-length SSS, precede first and second blocks (i.e., 256-FFT size blocks), each containing a pair of DM-RS at the beginning of the block (16% overhead total, with each DM-RS block corresponding to 8% overhead) and a portion of the PBCH. In the depicted embodiment, an additional guard-length DM-RS is added after the last block to fulfill the cyclic property.

FIG. 4D depicts a fourth example of SSB Type-3 structure 430, according to embodiments of the disclosure. In the SSB Type-3 structure 430, a 127-length PSS and a 127-length SSS, precede first, second, third, and fourth blocks (i.e., 128-FFT size blocks), each containing a DM-RS at the beginning of the block (7% overhead total) and a portion of the PBCH. In the depicted embodiment, an additional guard-length DM-RS is added after the last block to fulfill the cyclic property

In various embodiments, the length of the DM-RS block may depend upon the frequency spectrum that is being employed and may be defined in the specification. In NR Rel-16, the normal CP overhead is approximately 7%. However, using 256 length block size for PBCH gives a margin of approximately 16% overhead for DM-RS block if same bandwidth as of CP-OFDM is used. This gives a sufficient margin for better channels estimation especially for channels with high delay spread as guard-length is approximately the double as of what is being employed in NR Rel-16.

In a first embodiment, a DM-RS sequence with approximately 16% of block length is inserted at the beginning for PSS, SSS, and PBCH blocks, e.g., as shown in FIG. 4A. In order to ensure periodicity, an additional DM-RS block is also inserted at the end of PSS and SSS blocks while the remaining symbols in blocks 1 and 2 are not used. In an alternative implementation for FIG. 4A, two DM-RS blocks of 7% overhead size may be combined and inserted together where each block is scrambled with different sequence. Such implementation gives the option to either increase the number of ports or to give the flexibility to indicate some parameters or to increase the reliability of channel estimation.

In a second embodiment, two or multiple copies of the guard interval length DM-RS blocks are used in PSS and SSS blocks (first and second blocks) to further increase the reliability of channel estimation, where these are inserted either at the start or at the end of PSS/SSS sequences. For example, two DM-RS blocks with each 16% overhead size (in total 32% DM-RS overhead for two consecutive blocks plus 16% DM-RS overhead for third block) may be inserted only in the first and second blocks (before or after PSS/SSS sequence), as shown in FIG. 4B. In one implementation, both DM-RS blocks may be code-division multiplexing (“CDM”) scrambled. The SSB time duration for the examples in FIG. 4A and FIG. 4B is approximately the same as of SSB Type-1 and SSB Type-2 with 128-FFT block (in Table 2) for SSB bandwidths in Table 2.

In a third embodiment, SSB structure may be based on both single carrier waveform and SC-FDE. PSS and SSS may be decoded by UE in the time domain, therefore no guard interval may be added to PSS and SSS and are transmitted in the time domain while PBCH may transmitted with SC-FDE using either random guard interval or known guard interval. In case of known guard interval, DM-RS blocks are used as known guard interval while for random guard interval, a dedicated block is used for DM-RS. An example for such implementation with known guard interval is shown in FIG. 4C.

In a fourth embodiment, SSB pattern consists of four 128-FFT size PBCH blocks using SC-FDE with PSS and SSS using single carrier. The DM-RS blocks are employed only within PBCH with approximately 7% overhead, as shown in FIG. 4D.

In another embodiment, the position of PSS, SSS, and PBCH blocks may be interchanged. For instance, a PSS block may be followed by PBCH payload block, then by SSS block, and finally by last PBCH block for FIG. 4A and FIG. 4B. In some embodiments, the PSS is attached to (i.e., positioned immediately after or before) the known DM-RS or a CP segment in order to enable longer sequence detection at the receiver for PSS, when receiver is capable of time-domain processing.

In another embodiment, a similar to SSB Type-2, a dedicated DM-RS block may be included in a SSB Type-3, in addition to the DM-RS used as a guard interval.

According to embodiments of a third solution, the payload of PSS (or SSS) and DM-RS sequences are designed to embed the guard intervals as part of the synchronization sequence, in order to take advantage of the time domain processing capability at the receiver.

In some embodiments, the primary or secondary synchronization sequence is designed such that it automatically satisfies the cyclic property (in accordance with the FFT block

length) and thereby eliminates the need to a dedicated CP at the end of the block duration, e.g., for SSB Type-2. The intention is to improve the performance of the time domain processing at the receiver (due to the longer sequence duration), enabling both frequency domain as well as the time domain processing possibilities, depending on the receiver capability during the initial procedure.

In some embodiments, the extra duration of synchronization signals (due to the augmentation of CP as part of the PSS/SSS) can be reduced by introducing an unused interval (zero-sequence) at the beginning or at the end of the PSS and/or SSS sequences.

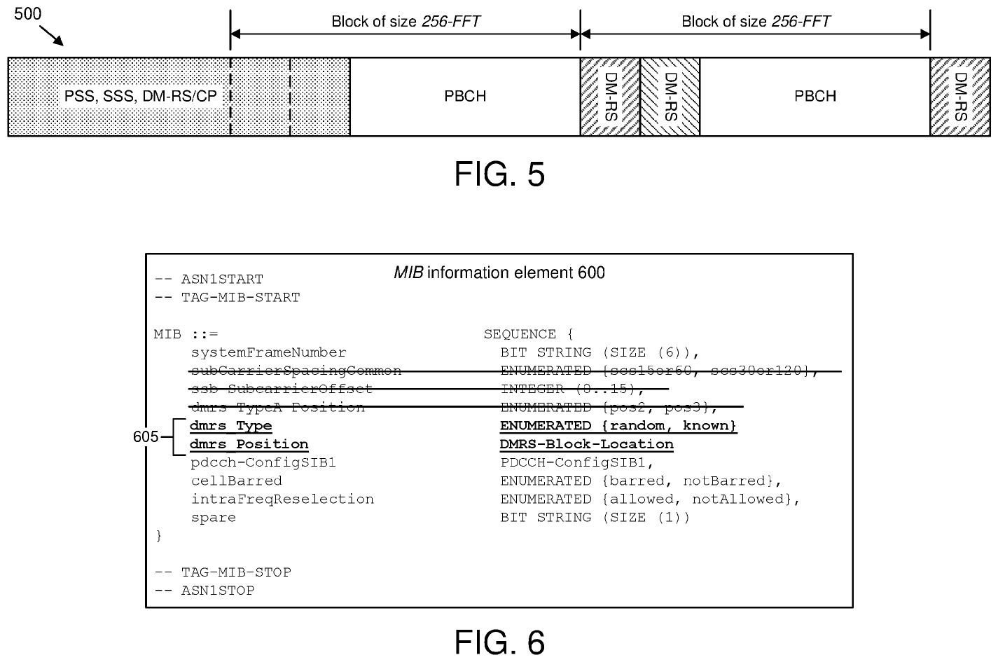

FIG. 5 depicts an example SC-SSB configuration 500 where the DM-RS/CP is embedded into the PSS/SSS. In some embodiments, the synchronization sequence is designed such that it automatically satisfies the known guard interval sequence (e.g., DM-RS sequence), in accordance with the FFT block length. In some embodiments, the DM-RS is designed such that it inherently complies with the PSS/SSS and acts as a part of the PSS/SSS, thereby reducing the dedicated PSS/SSS length.

In some embodiments, the PSS and SSS sequences do not end at the end of the block boundary (as they comply with the cyclic property or the known guard interval sequence following the abovementioned embodiments) and extend to the next block. In some embodiments, the additional flexibility for synchronization signal positioning may be used to indicate additional information during the initial access procedure, e.g., where one of the PSS or SSS starting points can be variable and indicate an additional information.

In some embodiments, the multiple DM-RS occasions can be integrated into the PSS/SSS sequences. Upon the conclusion of the synchronization process, the same DM-RS resources and/or PSS/SSS are further used for PBCH demodulation.

In some embodiments, the PSS and SSS time allocations may be superimposed. In this case, the payload of the PSS and SSS are designed such that they satisfy some orthogonality conditions.

According to embodiments of a fourth solution, PBCH payload contains only time domain resource mapping parameters. The field subCarrierSpacingCommon may be omitted since it defines the subcarrier spacing for SIB1, Msg 2/4 for initial access, paging and broadcast System Information messages that may not be valid if single carrier waveforms are employed for these purposes. The field “ssb-SubcarrierOffset” may be omitted or translate into new definitions for single carrier waveform, since it corresponds to parameter k_{SSB} that defines the frequency domain offset between SSB and the overall resource block grid in number of subcarriers.

For instance, the field “ssb-SubcarrierOffset” may define the time domain offset in terms of blocks between SSB and SIB1. The Information Element (“ IE”) field “pdcch-ConfigSIB1” require modification to configure CORESET#0 resources for single carrier waveform. In one implementation, a new table may be added in 3GPP TS 38.213 clause 13 that defines the SC-FDE parameters for CORESET#0, e.g., CORESET#0 bandwidth, FFT block length size, and number of time-domain blocks. In certain implementations, the field “dmrs-TypeA-Position” may not be valid for SC-FDE/single carrier waveform.

FIG. 6 depicts one example of an enhanced MIB 600 with one or more new DM-RS related fields 605, according to embodiments of the disclosure. In one implementation, a new DM-RS related field may be added in MIB, e.g., IE “dmrs-Type” that defines either random or known guard interval-based DM-RS configuration for downlink and uplink. In another implementation, additional information such as DM-RS block location and additional DM-RS blocks position (in case of DM-RS used as guard interval) may either be defined IE “dmrs-Type” with the help of a configuration table or is additionally configured with a new IE “dmrs-Position.”

According to embodiments of a fifth solution, the multiplexing patterns for SSB and PDCCH CORESET#0 are redesigned for SC-FDE waveform to have one or multiple N-FFT size blocks for multiplexing CORESET#0 with SSB in time domain only.

In one implementation, the same size block is used for each of SSB (PSS/SSS/PBCH) and PDCCH CORESET#0 and the number of blocks for CORESET#0 are determined based on the size of the block that is employed. For example, when 256-FFT size block is employed, then two blocks for PDCCH CORESET#0 are determined. In another example, when 128-FFT size blocks are employed, then four blocks for PDCCH CORESET#0 are determined.

In one implementation, the PDCCH CORESET#0 blocks are multiplexed in time-domain such that the PSS and SSS blocks are added before the PDCCH CORESET#0 blocks and PBCH blocks are added after the PDCCH CORESET#0 blocks.

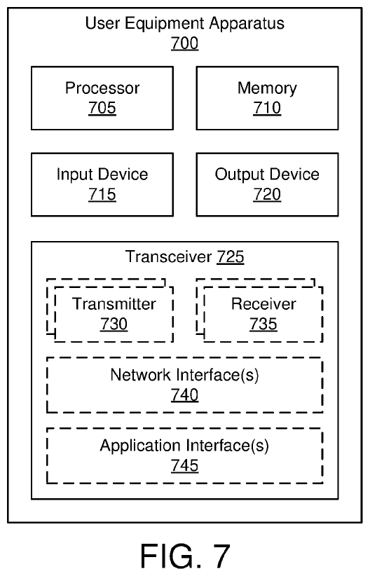

FIG. 7 depicts a user equipment apparatus 700 that may be used for SSB pattern enhancement, according to embodiments of the disclosure. In various embodiments, the user equipment apparatus 700 is used to implement one or more of the solutions described above. The user equipment apparatus 700 may be one embodiment of a user endpoint, such as the remote unit 105 and/or the UE 205, as described above. Furthermore, the user equipment apparatus 700 may include a processor 705, a memory 710, an input device 715, an output device 720, and a transceiver 725.

In some embodiments, the input device 715 and the output device 720 are combined into a single device, such as a touchscreen. In certain embodiments, the user equipment apparatus 700 may not include any input device 715 and/or output device 720. In various embodiments, the user equipment apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. In some embodiments, the transceiver 725 communicates with one or more cells (or wireless coverage areas) supported by one or more base units 121. In various embodiments, the transceiver 725 is operable on unlicensed spectrum. Moreover, the transceiver 725 may include multiple UE panels supporting one or more beams. Additionally, the transceiver 725 may support at least one network interface 740 and/or application interface 745. The application interface(s) 745 may support one or more APIs. The network interface(s) 740 may support 3GPP reference points, such as Uu, N1, PC5, etc. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the processor 705 controls the user equipment apparatus 700 to implement the above-described UE behaviors. In certain embodiments, the processor 705 may include an application processor (also known as “main processor”) which manages application-domain and operating system (“OS”) functions and a baseband processor (also known as “baseband radio processor”) which manages radio functions.

In various embodiments, via the transceiver 725, the processor 705 receives a SC-SSB structure from a RAN node (e.g., a gNB) and accesses a cell using a single-carrier waveform based on the received SC-SSB structure. Here, the SC-SSB structure includes: A) a PSS portion comprising a PSS block mapped to a first set of time-domain symbols (e.g., a first time-domain block): 2) a SSS portion comprising a SSS block mapped to a second set of time-domain symbols (e.g., a second timer-domain block): and 3) a PBCH portion comprising a plurality of PBCH blocks mapped to a third set of time-domain symbols (e.g., a plurality of third time-domain blocks).

In some embodiments, the SC-SSB structure includes a guard interval inserted between the second and third sets of time-domain symbols. In certain embodiments, the guard interval comprises a random block-wise guard interval (e.g., CP). In certain embodiments, the guard interval comprises a known DM-RS.

In certain embodiments, the third set of time-domain symbols comprises a plurality of time-domain blocks. In such embodiments, the SC-SSB structure comprises the guard interval inserted between each of the plurality of time-domain blocks in the third set of time-domain symbols. In certain embodiments, the SC-SSB structure comprises respective guard intervals inserted at a beginning of each of the first and second sets of time-domain symbols.

In some embodiments, the PSS block comprises a 127 element PSS sequence and the SSS block comprises a 127 element SSS sequence. In certain embodiments, the PSS block is mapped to a first set of 128 time-domain symbols and the SSS block is mapped to a second set of 128 time-domain symbols. In other embodiments, the PSS block is mapped to a first set of 256 time-domain symbols and the SSS block is mapped to a second set of 256 time-domain symbols.

In some embodiments, the PSS block is mapped to a first set of 128 time-domain symbols and the SSS block is mapped to a second set of 128 time-domain symbols. In certain embodiments, the PBCH blocks are mapped to multiple sets of 128 time-domain symbols. In other embodiments, the PBCH blocks are mapped to multiple sets of 256 time-domain symbols.

In some embodiments, the PSS block and the SSS block are mapped to a common time-domain block. In certain embodiments, the PSS block and/or the SSS block comprises a DM-RS. In some embodiments, the processor is further configured to cause the apparatus to receive a MIB comprising parameters restricted to the time domain.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to SSB pattern enhancement. For example, the memory 710 may store various parameters, panel/beam configurations, resource assignments, policies, and the like as described above. In certain embodiments, the memory 710 also stores program code and related data, such as an operating system or other controller algorithms operating on the user equipment apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 720 may include a wearable display separate from, but communicatively coupled to, the rest of the user equipment apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 communicates with one or more network functions of a mobile communication network via one or more access networks. The transceiver 725 operates under the control of the processor 705 to transmit messages, data, and other signals and also to receive messages, data, and other signals. For example, the processor 705 may selectively activate the transceiver 725 (or portions thereof) at particular times in order to send and receive messages.

The transceiver 725 includes at least transmitter 730 and at least one receiver 735. One or more transmitters 730 may be used to provide UL communication signals to a base unit 121, such as the UL transmissions described herein. Similarly, one or more receivers 735 may be used to receive DL communication signals from the base unit 121, as described herein. Although only one transmitter 730 and one receiver 735 are illustrated, the user equipment apparatus 700 may have any suitable number of transmitters 730 and receivers 735. Further, the transmitter(s) 730 and the receiver(s) 735 may be any suitable type of transmitters and receivers. In one embodiment, the transceiver 725 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example, a single chip performing functions for use with both licensed and unlicensed radio spectrum. In some embodiments, the first transmitter/receiver pair and the second transmitter/receiver pair may share one or more hardware components. For example, certain transceivers 725, transmitters 730, and receivers 735 may be implemented as physically separate components that access a shared hardware resource and/or software resource, such as for example, the network interface 740.

In various embodiments, one or more transmitters 730 and/or one or more receivers 735 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 730 and/or one or more receivers 735 may be implemented and/or integrated into a multi-chip module. In some embodiments, other components such as the network interface 740 or other hardware components/circuits may be integrated with any number of transmitters 730 and/or receivers 735 into a single chip. In such embodiment, the transmitters 730 and receivers 735 may be logically configured as a transceiver 725 that uses one more common control signals or as modular transmitters 730 and receivers 735 implemented in the same hardware chip or in a multi-chip module.

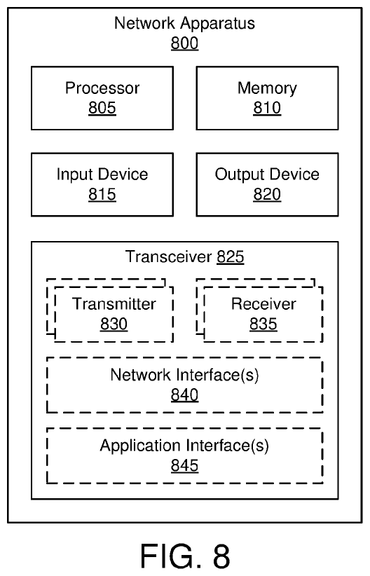

FIG. 8 depicts a network apparatus 800 that may be used for SSB pattern enhancement, according to embodiments of the disclosure. In one embodiment, network apparatus 800 may be one implementation of a network endpoint, such as the base unit 121 and/or RAN node 210, as described above. Furthermore, the network apparatus 800 may include a processor 805, a memory 810, an input device 815, an output device 820, and a transceiver 825.

In some embodiments, the input device 815 and the output device 820 are combined into a single device, such as a touchscreen. In certain embodiments, the network apparatus 800 may not include any input device 815 and/or output device 820. In various embodiments, the network apparatus 800 may include one or more of: the processor 805, the memory 810, and the transceiver 825, and may not include the input device 815 and/or the output device 820.

As depicted, the transceiver 825 includes at least one transmitter 830 and at least one receiver 835. Here, the transceiver 825 communicates with one or more remote units 105. Additionally, the transceiver 825 may support at least one network interface 840 and/or application interface 845. The application interface(s) 845 may support one or more APIs. The network interface(s) 840 may support 3GPP reference points, such as Uu, N1, N2 and N3. Other network interfaces 840 may be supported, as understood by one of ordinary skill in the art.

The processor 805, in one embodiment, may include any known controller capable of executing computer-readable instructions and/or capable of performing logical operations. For example, the processor 805 may be a microcontroller, a microprocessor, a CPU, a GPU, an auxiliary processing unit, a FPGA, or similar programmable controller. In some embodiments, the processor 805 executes instructions stored in the memory 810 to perform the methods and routines described herein. The processor 805 is communicatively coupled to the memory 810, the input device 815, the output device 820, and the transceiver 825.

In various embodiments, the network apparatus 800 is a RAN node (e.g., gNB) that communicates with one or more UEs, as described herein. In such embodiments, the processor 805 controls the network apparatus 800 to perform the above-described RAN behaviors. When operating as a RAN node, the processor 805 may include an application processor (also known as “main processor”) which manages application-domain and operating system (“OS”) functions and a baseband processor (also known as “baseband radio processor”) which manages radio functions.

In various embodiments, via the transceiver 825, the processor 805 transmits a SC-SSB structure and receives a connection request from a UE. Here, the SC-SSB structure includes: A) a PSS portion comprising a PSS block mapped to a first set of time-domain symbols (e.g., a first time-domain block): 2) a SSS portion comprising a SSS block mapped to a second set of time-domain symbols (e.g., a second timer-domain block): and 3) a PBCH portion comprising a plurality of PBCH blocks mapped to a third set of time-domain symbols (e.g., a plurality of third time-domain blocks).

In some embodiments, the SC-SSB structure includes a guard interval inserted between the second and third sets of time-domain symbols. In certain embodiments, the guard interval comprises a random block-wise guard interval (e.g., CP). In certain embodiments, the guard interval comprises a known DM-RS.

In certain embodiments, the third set of time-domain symbols comprises a plurality of time-domain blocks. In such embodiments, the SC-SSB structure comprises the guard interval inserted between each of the plurality of time-domain blocks in the third set of time-domain symbols. In certain embodiments, the SC-SSB structure comprises respective guard intervals inserted at a beginning of each of the first and second sets of time-domain symbols.

In some embodiments, the PSS block comprises a 127 element PSS sequence and the SSS block comprises a 127 element SSS sequence. In certain embodiments, the PSS block is mapped to a first set of 128 time-domain symbols and the SSS block is mapped to a second set of 128 time-domain symbols. In other embodiments, the PSS block is mapped to a first set of 256 time-domain symbols and the SSS block is mapped to a second set of 256 time-domain symbols.

In some embodiments, the PSS block is mapped to a first set of 128 time-domain symbols and the SSS block is mapped to a second set of 128 time-domain symbols. In certain embodiments, the plurality of PBCH blocks are mapped to multiple sets of 128 time-domain symbols. In other embodiments, the plurality of PBCH blocks are mapped to multiple sets of 256 time-domain symbols.

In some embodiments, the PSS block and the SSS block are mapped to a common time-domain block. In certain embodiments, the PSS block and/or the SSS block comprises a DM-RS. In some embodiments, the processor is further configured to cause the apparatus to receive a MIB comprising parameters restricted to the time domain.

The memory 810, in one embodiment, is a computer readable storage medium. In some embodiments, the memory 810 includes volatile computer storage media. For example, the memory 810 may include a RAM, including DRAM, SDRAM, and/or SRAM. In some embodiments, the memory 810 includes non-volatile computer storage media. For example, the memory 810 may include a hard disk drive, a flash memory, or any other suitable non-volatile computer storage device. In some embodiments, the memory 810 includes both volatile and non-volatile computer storage media.

In some embodiments, the memory 810 stores data related to SSB pattern enhancement. For example, the memory 810 may store parameters, configurations, resource assignments, policies, and the like, as described above. In certain embodiments, the memory 810 also stores program code and related data, such as an operating system or other controller algorithms operating on the network apparatus 800.

The input device 815, in one embodiment, may include any known computer input device including a touch panel, a button, a keyboard, a stylus, a microphone, or the like. In some embodiments, the input device 815 may be integrated with the output device 820, for example, as a touchscreen or similar touch-sensitive display. In some embodiments, the input device 815 includes a touchscreen such that text may be input using a virtual keyboard displayed on the touchscreen and/or by handwriting on the touchscreen. In some embodiments, the input device 815 includes two or more different devices, such as a keyboard and a touch panel.

The output device 820, in one embodiment, is designed to output visual, audible, and/or haptic signals. In some embodiments, the output device 820 includes an electronically controllable display or display device capable of outputting visual data to a user. For example, the output device 820 may include, but is not limited to, an LCD display, an LED display, an OLED display, a projector, or similar display device capable of outputting images, text, or the like to a user. As another, non-limiting, example, the output device 820 may include a wearable display separate from, but communicatively coupled to, the rest of the network apparatus 800, such as a smart watch, smart glasses, a heads-up display, or the like. Further, the output device 820 may be a component of a smart phone, a personal digital assistant, a television, a table computer, a notebook (laptop) computer, a personal computer, a vehicle dashboard, or the like.

In certain embodiments, the output device 820 includes one or more speakers for producing sound. For example, the output device 820 may produce an audible alert or notification (e.g., a beep or chime). In some embodiments, the output device 820 includes one or more haptic devices for producing vibrations, motion, or other haptic feedback. In some embodiments, all or portions of the output device 820 may be integrated with the input device 815. For example, the input device 815 and output device 820 may form a touchscreen or similar touch-sensitive display. In other embodiments, the output device 820 may be located near the input device 815.

The transceiver 825 includes at least transmitter 830 and at least one receiver 835. One or more transmitters 830 may be used to communicate with the UE, as described herein. Similarly, one or more receivers 835 may be used to communicate with network functions in the PLMN and/or RAN, as described herein. Although only one transmitter 830 and one receiver 835 are illustrated, the network apparatus 800 may have any suitable number of transmitters 830 and receivers 835. Further, the transmitter(s) 830 and the receiver(s) 835 may be any suitable type of transmitters and receivers.

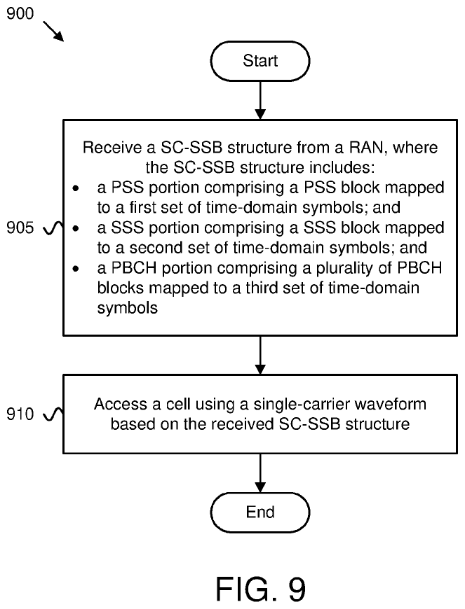

FIG. 9 depicts one embodiment of a method 900 for SSB pattern enhancement, according to embodiments of the disclosure. In various embodiments, the method 900 is performed by a communication device, such as a remote unit 105, a UE 205, and/or the user equipment apparatus 700, described above. In some embodiments, the method 900 is performed by a processor, such as a microcontroller, a microprocessor, a CPU, a GPU, an auxiliary processing unit, a FPGA, or the like.

The method 900 includes receiving 905 a SC-SSB structure from a RAN, where the SC-SSB structure includes: 1) a PSS portion comprising a PSS block mapped to a first set of time-domain symbols: 2) a SSS portion comprising a SSS block mapped to a second set of time-domain symbols: and 3) a PBCH portion comprising a plurality of PBCH blocks mapped to a third set of time-domain symbols. The method 900 includes accessing 910 a cell using a single-carrier waveform based on the received SC-SSB structure. The method 900 ends.

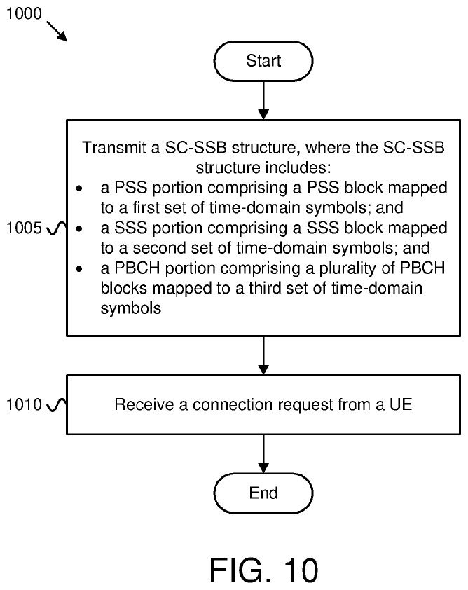

FIG. 10 depicts one embodiment of a method 1000 for SSB pattern enhancement, according to embodiments of the disclosure. In various embodiments, the method 1000 is performed by a network device, such as the base unit 121, the RAN node 210, and/or the network apparatus 800, as described above. In some embodiments, the method 1000 is performed by a processor, such as a microcontroller, a microprocessor, a CPU, a GPU, an auxiliary processing unit, a FPGA, or the like.

The method 1000 includes transmitting 1005 a SC-SSB structure, where the SC-SSB structure includes: 1) a PSS portion comprising a PSS block mapped to a first set of time-domain symbols: 2) a SSS portion comprising a SSS block mapped to a second set of time-domain symbols: and 3) a PBCH portion comprising a plurality of PBCH blocks mapped to a third set of time-domain symbols. The method 1000 includes receiving 1010 a connection request from a UE. The method 1000 ends.

Disclosed herein is a first apparatus for SSB pattern enhancement, according to embodiments of the disclosure. The first apparatus may be implemented by a communication device, such as a remote unit 105, a UE 205, and/or the user equipment apparatus 700, described above. The first apparatus includes a processor coupled to a transceiver, the transceiver configured to communicate with a mobile communication network and the processor configured to cause the apparatus to: A) receive a SC-SSB structure from a radio access network (e.g., a gNB): and B) access a cell using a single-carrier waveform based on the received SC-SSB structure. Here, the SC-SSB structure includes: 1) a PSS portion comprising a PSS block mapped to a first set of time-domain symbols: 2) a SSS portion comprising a SSS block mapped to a second set of time-domain symbols: and 3) a PBCH portion comprising a plurality of PBCH blocks mapped to a third set of time-domain symbols.

In some embodiments, the SC-SSB structure includes a guard interval inserted between the second and third sets of time-domain symbols. In certain embodiments, the guard interval comprises a random block-wise guard interval (e.g., CP). In certain embodiments, the guard interval comprises a known DM-RS.

In certain embodiments, the third set of time-domain symbols comprises a plurality of time-domain blocks. In such embodiments, the SC-SSB structure comprises the guard interval inserted between each of the plurality of time-domain blocks in the third set of time-domain symbols. In certain embodiments, the SC-SSB structure comprises respective guard intervals inserted at a beginning of each of the first and second sets of time-domain symbols.

In some embodiments, the PSS block comprises a 127 element PSS sequence and the SSS block comprises a 127 element SSS sequence. In certain embodiments, the PSS block is mapped to a first set of 128 time-domain symbols and the SSS block is mapped to a second set of 128 time-domain symbols. In other embodiments, the PSS block is mapped to a first set of 256 time-domain symbols and the SSS block is mapped to a second set of 256 time-domain symbols.

In some embodiments, the PSS block is mapped to a first set of 128 time-domain symbols and the SSS block is mapped to a second set of 128 time-domain symbols. In certain embodiments, the plurality of PBCH blocks are mapped to multiple sets of 128 time-domain symbols. In other embodiments, the plurality of PBCH blocks are mapped to multiple sets of 256 time-domain symbols.

In some embodiments, the PSS block and the SSS block are mapped to a common time-domain block. In certain embodiments, the PSS block and/or the SSS block comprises a DM-RS. In some embodiments, the processor is further configured to cause the apparatus to receive a MIB comprising parameters restricted to the time domain.

Disclosed herein is a first method for SSB pattern enhancement, according to embodiments of the disclosure. The first method may be performed by a communication device, such as a remote unit 105, a UE 205, and/or the user equipment apparatus 700, described above. The first method includes receiving a SC-SSB structure from a RAN (e.g., gNB) and accessing a cell using a single-carrier waveform based on the received SC-SSB structure. Here, the SC-SSB structure includes: 1) a PSS portion comprising a PSS block mapped to a first set of time-domain symbols: 2) a SSS portion comprising a SSS block mapped to a second set of time-domain symbols: and 3) a PBCH portion comprising a plurality of PBCH blocks mapped to a third set of time-domain symbols.

In some embodiments, the SC-SSB structure includes a guard interval inserted between the second and third sets of time-domain symbols. In certain embodiments, the guard interval comprises a random block-wise guard interval (e.g., CP). In certain embodiments, the guard interval comprises a known DM-RS.

In certain embodiments, the third set of time-domain symbols comprises a plurality of time-domain blocks. In such embodiments, the SC-SSB structure comprises the guard interval inserted between each of the plurality of time-domain blocks in the third set of time-domain symbols. In certain embodiments, the SC-SSB structure comprises respective guard intervals inserted at a beginning of each of the first and second sets of time-domain symbols.

In some embodiments, the PSS block comprises a 127 element PSS sequence and the SSS block comprises a 127 element SSS sequence. In certain embodiments, the PSS block is mapped to a first set of 128 time-domain symbols and the SSS block is mapped to a second set of 128 time-domain symbols. In other embodiments, the PSS block is mapped to a first set of 256 time-domain symbols and the SSS block is mapped to a second set of 256 time-domain symbols.

In some embodiments, the PSS block is mapped to a first set of 128 time-domain symbols and the SSS block is mapped to a second set of 128 time-domain symbols. In certain embodiments, the plurality of PBCH blocks are mapped to multiple sets of 128 time-domain symbols. In other embodiments, the plurality of PBCH blocks are mapped to multiple sets of 256 time-domain symbols.

In some embodiments, the PSS block and the SSS block are mapped to a common time-domain block. In certain embodiments, the PSS block and/or the SSS block comprises a DM-RS. In some embodiments, the processor is further configured to cause the apparatus to receive a MIB comprising parameters restricted to the time domain.

Disclosed herein is a second apparatus for SSB pattern enhancement, according to embodiments of the disclosure. The second apparatus may be implemented by a network device, such as the base unit 121, the RAN node 210, and/or the network apparatus 800, as described above. The second apparatus includes a processor coupled to a transceiver, the transceiver configured to communicate with a UE and the processor configured to cause the apparatus to: A) transmit a SC-SSB structure: and B) receive a connection request from the UE. Here, the SC-SSB structure includes: 1) a PSS portion comprising a PSS block mapped to a first set of time-domain symbols: 2) a SSS portion comprising a SSS block mapped to a second set of time-domain symbols: and 3) a PBCH portion comprising a plurality of PBCH blocks mapped to a third set of time-domain symbols.

In some embodiments, the SC-SSB structure includes a guard interval inserted between the second and third sets of time-domain symbols. In certain embodiments, the guard interval comprises a random block-wise guard interval (e.g., CP). In certain embodiments, the guard interval comprises a known DM-RS.

In certain embodiments, the third set of time-domain symbols comprises a plurality of time-domain blocks. In such embodiments, the SC-SSB structure comprises the guard interval inserted between each of the plurality of time-domain blocks in the third set of time-domain symbols. In certain embodiments, the SC-SSB structure comprises respective guard intervals inserted at a beginning of each of the first and second sets of time-domain symbols.

In some embodiments, the PSS block comprises a 127 element PSS sequence and the SSS block comprises a 127 element SSS sequence. In certain embodiments, the PSS block is mapped to a first set of 128 time-domain symbols and the SSS block is mapped to a second set of 128 time-domain symbols. In other embodiments, the PSS block is mapped to a first set of 256 time-domain symbols and the SSS block is mapped to a second set of 256 time-domain symbols.

In some embodiments, the PSS block is mapped to a first set of 128 time-domain symbols and the SSS block is mapped to a second set of 128 time-domain symbols. In certain embodiments, the plurality of PBCH blocks are mapped to multiple sets of 128 time-domain symbols. In other embodiments, the plurality of PBCH blocks are mapped to multiple sets of 256 time-domain symbols.

In some embodiments, the PSS block and the SSS block are mapped to a common time-domain block. In certain embodiments, the PSS block and/or the SSS block comprises a DM-RS. In some embodiments, the processor is further configured to cause the apparatus to receive a MIB comprising parameters restricted to the time domain.

Disclosed herein is a second method for SSB pattern enhancement, according to embodiments of the disclosure. The second method may be performed by a network device, such as the base unit 121, the RAN node 210, and/or the network apparatus 800, as described above. The second method includes transmitting a SC-SSB structure and receiving a connection request from a UE. Here, the SC-SSB structure includes: 1) a PSS portion comprising a PSS block mapped to a first set of time-domain symbols: 2) a SSS portion comprising a SSS block mapped to a second set of time-domain symbols: and 3) a PBCH portion comprising a plurality of PBCH blocks mapped to a third set of time-domain symbols.

In some embodiments, the SC-SSB structure includes a guard interval inserted between the second and third sets of time-domain symbols. In certain embodiments, the guard interval comprises a random block-wise guard interval (e.g., CP). In certain embodiments, the guard interval comprises a known DM-RS.

In certain embodiments, the third set of time-domain symbols comprises a plurality of time-domain blocks. In such embodiments, the SC-SSB structure comprises the guard interval inserted between each of the plurality of time-domain blocks in the third set of time-domain symbols. In certain embodiments, the SC-SSB structure comprises respective guard intervals inserted at a beginning of each of the first and second sets of time-domain symbols.

In some embodiments, the PSS block comprises a 127 element PSS sequence and the SSS block comprises a 127 element SSS sequence. In certain embodiments, the PSS block is mapped to a first set of 128 time-domain symbols and the SSS block is mapped to a second set of 128 time-domain symbols. In other embodiments, the PSS block is mapped to a first set of 256 time-domain symbols and the SSS block is mapped to a second set of 256 time-domain symbols.

In some embodiments, the PSS block is mapped to a first set of 128 time-domain symbols and the SSS block is mapped to a second set of 128 time-domain symbols. In certain embodiments, the plurality of PBCH blocks are mapped to multiple sets of 128 time-domain symbols. In other embodiments, the plurality of PBCH blocks are mapped to multiple sets of 256 time-domain symbols.

In some embodiments, the PSS block and the SSS block are mapped to a common time-domain block. In certain embodiments, the PSS block and/or the SSS block comprises a DM-RS. In some embodiments, the processor is further configured to cause the apparatus to receive a MIB comprising parameters restricted to the time domain.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus comprising:
a transceiver; and
a processor coupled to the transceiver, the processor configured to cause the apparatus to:
receive a single-carrier Synchronization Signal Block (“SC-SSB”) structure from a radio access network,
wherein the SC-SSB structure comprises:
a Primary Synchronization Signal (“PSS”) portion comprising a PSS block mapped to a first set of time-domain symbols:
a Secondary Synchronization Signal (“SSS”) portion comprising a SSS block mapped to a second set of time-domain symbols; and
a Physical Broadcast Channel (“PBCH”) portion comprising a plurality of PBCH blocks mapped to a third set of time-domain symbols; and
access a cell using a single-carrier waveform based on the received SC-SSB structure.

2. The apparatus of claim 1, wherein the SC-SSB structure comprises a guard interval inserted between the second and third sets of time-domain symbols.

3. The apparatus of claim 2, wherein the guard interval comprises a random block-wise guard interval.

4. The apparatus of claim 2, wherein the guard interval comprises a known demodulation reference signal (“DM-RS”).

5. The apparatus of claim 2, wherein the third set of time-domain symbols comprises a plurality of time-domain blocks, wherein the SC-SSB structure comprises the guard interval inserted between each of the plurality of time-domain blocks.

6. The apparatus of claim 2, wherein the SC-SSB structure comprises respective guard intervals inserted at a beginning of each of the first and second sets of time-domain symbols.

7. The apparatus of claim 1, wherein the PSS block comprises a 127 element PSS sequence and the SSS block comprises a 127 element SSS sequence, wherein the PSS block is mapped to a first set of 128 time-domain symbols and the SSS block is mapped to a second set of 128 time-domain symbols.

8. The apparatus of claim 1, wherein the PSS block comprises a 127 element PSS sequence and the SSS block comprises a 127 element SSS sequence, wherein the PSS block is mapped to a first set of 256 time-domain symbols and the SSS block is mapped to a second set of 256 time-domain symbols.

9. The apparatus of claim 1, wherein the PSS block is mapped to a first set of 128 time-domain symbols, wherein the SSS block is mapped to a second set of 128 time-domain symbols, and wherein the plurality of PBCH blocks are mapped to multiple sets of 128 time-domain symbols.

10. The apparatus of claim 1, wherein the PSS block is mapped to a first set of 128 time-domain symbols, wherein the SSS block is mapped to a second set of 128 time-domain symbols, and wherein the plurality of PBCH blocks are mapped to multiple sets of 256 time-domain symbols.

11. The apparatus of claim 1, wherein the PSS block and the SSS block are mapped to a common time-domain block.

12. The apparatus of claim 11, wherein the PSS block and/or the SSS block comprises a demodulation reference signal (“DM-RS”).

13. The apparatus of claim 1, wherein the processor is further configured to cause the apparatus to receive a master information block (“MIB”) comprising parameters restricted to the time domain.

14. A method of a User Equipment (“UE”), the method comprising:
receiving a single-carrier Synchronization Signal Block (“SC-SSB”) structure from a radio access network,
wherein the SC-SSB structure comprises:
a Primary Synchronization Signal (“PSS”) portion comprising a PSS block mapped to a first set of time-domain symbols:
a Secondary Synchronization Signal (“SSS”) portion comprising a SSS block mapped to a second set of time-domain symbols; and
a Physical Broadcast Channel (“PBCH”) portion comprising a plurality of PBCH blocks mapped to a third set of time-domain symbols; and
accessing a cell using a single-carrier waveform based on the received SC-SSB structure.

15. An apparatus comprising:
a transceiver; and
a processor coupled to the transceiver, the processor configured to cause the apparatus to:
transmit a single-carrier Synchronization Signal Block (“SC-SSB”) structure, wherein the SC-SSB structure comprises:
a Primary Synchronization Signal (“PSS”) portion comprising a PSS block mapped to a first set of time-domain symbols;
a Secondary Synchronization Signal (“SSS”) portion comprising a SSS block mapped to a second set of time-domain symbols; and
a Physical Broadcast Channel (“PBCH”) portion comprising a plurality of PBCH blocks mapped to a third set of time-domain symbols; and
receive a connection request from a User Equipment (“UE”).
